(19) United States
(12) Patent Application Publication
(10) Pub. No.: US 2014/0176878 A1
(43) Pub. Date: Jun. 26, 2014

(54) Isolated Boost Circuit, Backlight Module and Liquid Crystal Display Device Thereof

(71) Applicants: Hua Zhang, Shenzhen City (CN); Xiang Yang, Shenzhen City (CN)

(72) Inventors: Hua Zhang, Shenzhen City (CN); Xiang Yang, Shenzhen City (CN)

(73) Assignee: Shenzhen China Star Optoelectronics Technology Co. Ltd., Shenzhen, Guangdong (CN)

(21) Appl. No.: 13/810,466

(22) PCT Filed: Dec. 24, 2012
(86) PCT No.: PCT/CN12/87305

§ 371 Date: Jan. 16, 2013

(30) Foreign Application Priority Data
Dec. 20, 2012 (CN) 201210556683.X

(51) Int. Cl. H05B 33/08; G02F 1/1335

(52) U.S. Cl. CPC H05B 33/0839; G02F 1/1336
USPC 349/69; 315/188

(57) ABSTRACT

The present invention provides an isolated boost circuit, a backlight module and a liquid crystal display device. The isolated boost circuit provides power for the LED light string in the backlight module of the liquid crystal display device, which comprises a voltage input terminal, a driving signal unit, a transformer, and a controllable reverse isolation circuit. Wherein, the transformer comprises a primary coil and a secondary coil. The voltage input terminal is connected to the dotted terminal of the primary coil, and the opposite terminal of the secondary coil is connected to the LED light string. The opposite terminal of the primary coil is connected to a 01 terminal of the controllable reverse isolation circuit, the dotted terminal of the secondary coil is connected to a 02 terminal of the controllable reverse isolation circuit, and a 03 terminal of the controllable reverse isolation circuit is connected to the driving signal unit. The isolated boost circuit can improve the efficiency of the entire circuit, and increase the safety and the stability of the circuit.

### BACKGROUND OF THE INVENTION

1. Field of the Invention

The present invention relates to the field of liquid crystal display, and in particular to an isolated boost circuit, a backlight module using the isolated boost circuit and a liquid crystal display device thereof.

2. The Related Arts

At present, LED is usually used as the backlight of the liquid crystal display device. FIG. 1 is a schematic view illustrating a backlight boost circuit of LED according to the known technology. As shown in FIG. 1, the dotted terminal of the primary coil of the transformer T900 is connected to the positive electrode of diode D1, and the dotted terminal of the secondary coil is connected to the negative electrode of the diode. When the driving signal unit 901 sends ON signal to the MOS transistor Q1, the MOS transistor Q1 is turned on, and the diode D1 prevents the MOS transistor Q1 from being damaged by the high voltage of the secondary coil of the transformer T900; when the driving signal unit 901 sends OFF signal to the MOS transistor Q1, the MOS transistor Q1 is cut off, and the primary coil of the transformer T900 is connected to the induced electromotive force on the secondary coil in series for the LED light string 30, which effectively increases the output voltage by changing the turn ratio of the primary coil to the secondary coil.

However, in the above circuit, when the MOS transistor Q1 is turned on, the diode D1 between the primary coil and the secondary coil of the transformer T900 reversely isolates the high voltage on the secondary coil. There is reverse current existing in the diode D1, which will consume the power and increase the temperature in the diode D1. Moreover, the reverse current will increase as the temperature of the diode D1 increases. Such vicious cycle results the increased power consumption of the diode D1 and high temperature, which reduces the efficiency of the entire circuit. On the other hand, there is leakage inductance existing in the transformer T900. When the MOS Q1 is turned on, the energy stored in the leakage inductance will released a big spike voltage after the MOS transistor Q1 is turned off, which impacts the diode D1 and the MOS Q1, accelerates the aging thereof, and even causes breakdown.

### SUMMARY OF THE INVENTION

The technical issue to be solved by the present invention is to provide an isolated boost circuit which comprises a voltage input terminal, a driving signal unit, a transformer, and a controllable reverse isolation circuit. Wherein, the transformer comprises a primary coil and a secondary coil. The voltage input terminal is connected to the dotted terminal of the primary coil. The opposite terminal of the primary coil is connected to a 01 terminal of the controllable reverse isolation circuit. The dotted terminal of the secondary coil is connected to a 02 terminal of the controllable reverse isolation circuit. A 03 terminal of the controllable reverse isolation circuit is connected to the driving signal unit.

Furthermore, the controllable reverse isolation circuit comprises a second MOS transistor, inside which a first diode and a second capacitor are provided; one end of the second capacitor is connected to the positive electrode of the first diode and the source of the second MOS transistor, which forms the 01 terminal of the controllable reverse isolation circuit; the other end of the second capacitor is connected to the negative electrode of the first diode and the drain of the second MOS transistor, which forms the 02 terminal of the controllable reverse isolation circuit; and the gate of the second MOS transistor is provided as the 03 terminal of the controllable reverse isolation circuit.

Furthermore, the isolated boost circuit further comprises a first MOS transistor, a first capacitor, a LED light string, and a resistance; the drain of the first MOS transistor is connected to the opposite terminal of the primary coil, the source of that is electrically grounded, and the gate of that is connected to the driving signal unit; the opposite terminal of the secondary coil is connected to the positive electrode of the LED light string; one end of the resistance is connected to the negative electrode of the LED light string, and the other end of that is electrically grounded; and one end of the first capacitor is connected to the positive electrode of the LED light string, and the other end of that is electrically grounded.

Furthermore, the isolated boost circuit further comprises a rectifying circuit; a 04 terminal of the rectifying circuit is connected to the opposite terminal of the secondary coil, and a 05 terminal of the rectifying circuit is connected to the positive electrode of the LED light string, which allows the rectifying circuit connected between the opposite terminal of the secondary coil and the positive electrode of the LED light string.

Furthermore, the first diode is a Schottky diode.

Furthermore, the rectifying circuit is a second diode; the positive electrode of the second diode is connected to the opposite terminal of the secondary coil, and the negative electrode of the second diode is connected to positive electrode of the LED light string.

The other technical issue to be solved by the present invention is to provide a backlight module, comprising a isolated boost circuit which comprises a voltage input terminal, a driving signal unit, a transformer, and a controllable reverse isolation circuit; wherein, the transformer comprising a primary coil and a secondary coil, the voltage input terminal connected to the dotted terminal of the primary coil, the opposite terminal of the primary coil connected to a 01 terminal of the controllable reverse isolation circuit, the dotted terminal of the secondary coil connected to a 02 terminal of the controllable reverse isolation circuit, and a 03 terminal of the controllable reverse isolation circuit connected to the driving signal unit; wherein, the controllable reverse isolation circuit comprising a second MOS transistor, inside which a first diode and a second capacitor are provided; one end of the second capacitor connected to the positive electrode of the first diode and the source of the second MOS transistor, which forms the 01 terminal of the controllable reverse isolation circuit; the other end of the second capacitor connected to the negative electrode of the first diode and the drain of the second MOS transistor, which forms the 02 terminal of the controllable reverse isolation circuit; and the gate of the second MOS transistor provided as the 03 terminal of the controllable reverse isolation circuit.

Furthermore, the isolated boost circuit further comprises a first MOS transistor, a first capacitor, a LED light string, and a resistance; the drain of the first MOS transistor is connected to the opposite terminal of the primary coil, the source of that is electrically grounded, and the gate of that is connected to the driving signal unit; the opposite terminal of the secondary coil is connected to the positive electrode of the LED light string; one end of the resistance is connected to the negative electrode of the LED light string, and the other end of that is electrically grounded; and one end of the first capacitor is connected to the positive electrode of the LED light string, and the other end of that is electrically grounded.

Furthermore, the isolated boost circuit further comprises a rectifying circuit; a 04 terminal of the rectifying circuit is connected to the opposite terminal of the secondary coil, and a 05 terminal of the rectifying circuit is connected to the positive electrode of the LED light string, which allows the rectifying circuit connected between the opposite terminal of the secondary coil and the positive electrode of the LED light string.

Furthermore, the first diode is a Schottky diode.

Furthermore, the rectifying circuit is a second diode; the positive electrode of the second diode is connected to the opposite terminal of the secondary coil, and the negative electrode of the second diode is connected to positive electrode of the LED light string.

The other technical issue to be solved by the present invention is to provide a liquid crystal display device, comprising a liquid crystal panel and a backlight module which provides a light source to the liquid crystal panel; the backlight module comprising a isolated boost circuit which comprises a voltage input terminal, a driving signal unit, a transformer, and a controllable reverse isolation circuit; wherein, the transformer comprising a primary coil and a secondary coil, the voltage input terminal connected to the dotted terminal of the primary coil, the opposite terminal of the primary coil connected to a 01 terminal of the controllable reverse isolation circuit, the dotted terminal of the secondary coil connected to a 02 terminal of the controllable reverse isolation circuit, and a 03 terminal of the controllable reverse isolation circuit connected to the driving signal unit; wherein, the controllable reverse isolation circuit comprising a second MOS transistor, inside which a first diode and a second capacitor are provided; one end of the second capacitor connected to the positive electrode of the first diode and the source of the second MOS transistor, which forms the 01 terminal of the controllable reverse isolation circuit; the other end of the second capacitor connected to the negative electrode of the first diode and the drain of the second MOS transistor, which forms the 02 terminal of the controllable reverse isolation circuit; and the gate of the second MOS transistor provided as the 03 terminal of the controllable reverse isolation circuit.

Furthermore, the isolated boost circuit further comprises a first MOS transistor, a first capacitor, a LED light string, and a resistance; the drain of the first MOS transistor is connected to the opposite terminal of the primary coil, the source of that is electrically grounded, and the gate of that is connected to the driving signal unit; the opposite terminal of the secondary coil is connected to the positive electrode of the LED light string; one end of the resistance is connected to the negative electrode of the LED light string, and the other end of that is electrically grounded; and one end of the first capacitor is connected to the positive electrode of the LED light string, and the other end of that is electrically grounded.

Furthermore, the isolated boost circuit further comprises a rectifying circuit; a 04 terminal of the rectifying circuit is connected to the opposite terminal of the secondary coil, and a 05 terminal of the rectifying circuit is connected to the positive electrode of the LED light string, which allows the rectifying circuit connected between the opposite terminal of the secondary coil and the positive electrode of the LED light string.

Furthermore, the first diode is a Schottky diode.

Furthermore, the rectifying circuit is a second diode; the positive electrode of the second diode is connected to the opposite terminal of the secondary coil, and the negative electrode of the second diode is connected to positive electrode of the LED light string.

The isolated boost circuit according to the present invention provides power for the LED light string in the backlight module of the liquid crystal display device. By using the MOS transistor with low on-state losses of power instead of the ordinary diode to be connected between the opposite terminal of the primary coil and the dotted terminal of the secondary coil in the transformer, the Schottky diode inside the MOS transistor has higher cut off voltage and lower reverse current than the ordinary diode, which can increase the efficiency of the entire circuit. Moreover, the capacitor inside the MOS transistor can effectively absorb the pulse voltage released from the leakage inductance of the transformer, which effectively improves the security and stability of the circuit.

### BRIEF DESCRIPTION OF THE DRAWINGS

FIG. 1 is a schematic view illustrating an isolated boost circuit according to the known technology;

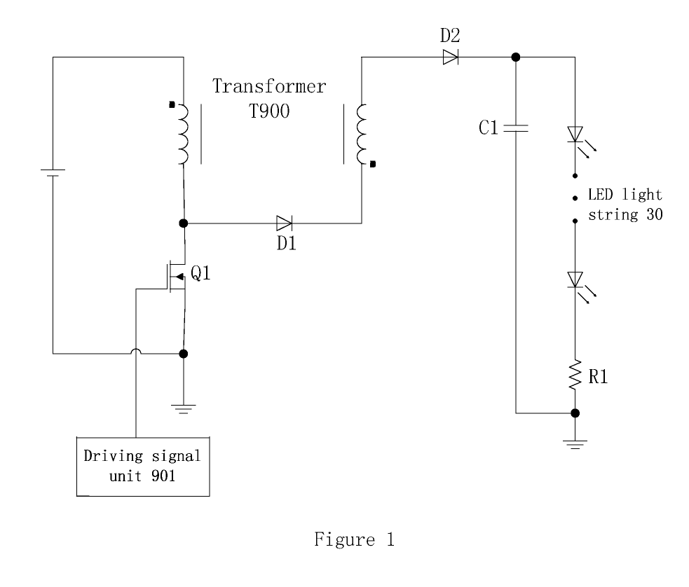

FIG. 2 is a schematic view illustrating an isolated boost circuit according to the embodiment of the present invention; and

FIG. 3 is a schematic view illustrating a controllable reverse isolation circuit according to the embodiment of the present invention.

### DETAILED DESCRIPTION OF THE PREFERRED EMBODIMENTS

In order to better illustrate the present invention and the effect thereof, the detailed descriptions accompanying drawings and the embodiment of the present invention are as follows. Wherein, the same reference numbers denote the same parts.

The isolated boost circuit according to the present invention is applied to the field of liquid crystal display, which provides power for the LED light string in the backlight module.

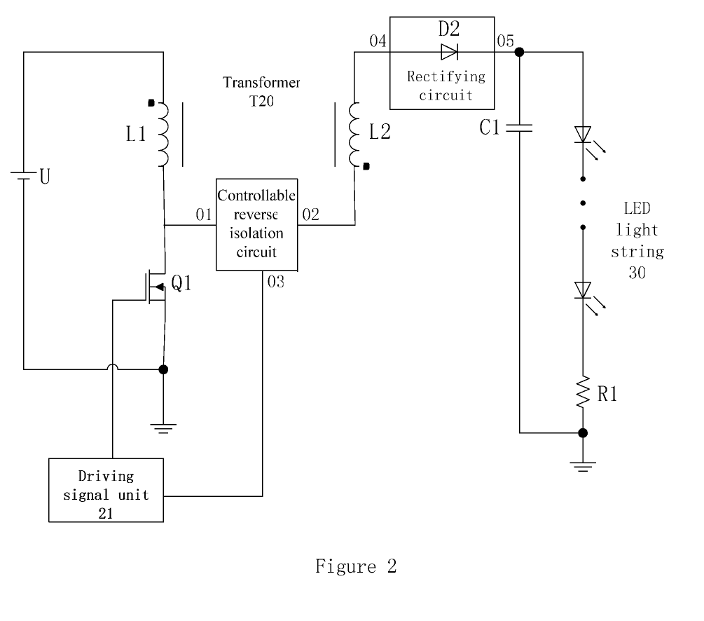

Referring to FIG. 2, FIG. 2 shows a schematic view illustrating an isolated boost circuit according to the embodiment of the present invention

The liquid crystal display device applied with the isolated boost circuit can comprise a liquid crystal and a backlight module which provides light to the liquid crystal panel. The backlight module comprises a parallel or series LED light string and an isolated boost circuit which provides power to the LED light string. The present embodiment takes the series LED light string as example.

The isolated boost circuit comprises a power source U, a transformer T20, a first transistor, a driving signal unit 21, a controllable reverse isolation circuit, a rectifying circuit, a first capacitor C1, a resistance R1, and a series LED light string 30. The voltage input terminal is the positive electrode of the power source U. The power source U is used to input a DC power to be boosted. The transformer T20 comprises a primary coil L1 and a secondary coil L2. The positive electrode of the power source U is connected to the dotted terminal of the primary coil L1 of the transformer T20, and the negative electrode of the power source U is electrically grounded. A 01 terminal of the controllable reverse isolation circuit is connected to the opposite terminal of the primary coil L1 of the transformer T20, a 02 terminal of the controllable reverse isolation circuit is connected to the dotted terminal of the secondary coil L2 of the transformer T20, and a 03 terminal of the controllable reverse isolation circuit is connected to the driving signal unit 21. The drain of a first MOS transistor Q1 is connected to the opposite terminal of the primary coil L1 of the transformer T20, the source of that is electrically grounded, and the gate of that is connected to the driving signal unit 21. A 04 terminal of the rectifying circuit is connected to the opposite terminal of the secondary coil of transformer T20, and a 05 terminal of the rectifying circuit is connected to the positive electrode of the series LED light string 30. The rectifying circuit can be a second diode D2 or other common rectifying circuit. One end of the resistance R1 is connected to the negative electrode of the series LED light string 30, and the other end of that is electrically grounded. One end of the first capacitor C1 is connected to the positive electrode of the series LED light string 30, and the other end of that is electrically grounded.

The isolated boost circuit according to the present embodiment, the controllable reverse isolation circuit can be replaced by an electronic switch with the function of isolation connectivity or an integrated IC. The function of isolation connectivity means able to isolate the high voltage on the secondary coil L2 of the transformer T20 when the MOS transistor Q1 is turned on, and to connect the primary coil L1 and the secondary coil L2 of the transformer T20 to act as the working voltage of the LED light string 30 when the MOS transistor Q1 is cut off.

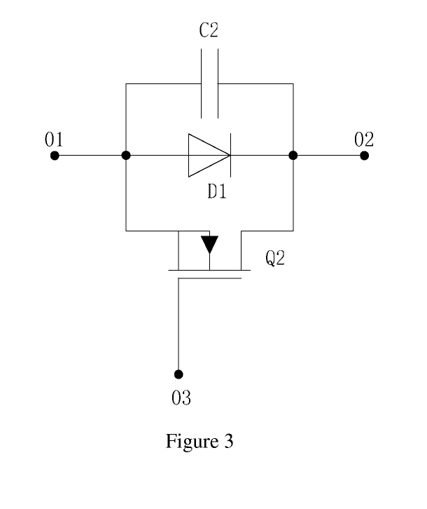

Referring to FIG. 3, FIG. 3 shows a schematic view illustrating a controllable reverse isolation circuit according to the embodiment of the present invention.

The controllable reverse isolation circuit comprises a second MOS transistor Q2 which is the MOS transistor with low on-state losses of power. A second capacitor C2 and a first diode D1 are provided inside the MOS transistor Q2. One end of the second capacitor C2 is connected to the positive electrode of the first diode D1 and the source of the second MOS transistor Q2, which forms the 01 terminal of the controllable reverse isolation circuit; the other end of the second capacitor C2 is connected to the negative electrode of the first diode D1 and the drain of the second MOS transistor Q2, which forms the 02 terminal of the controllable reverse isolation circuit; and the gate of the second MOS transistor Q2 is provided as the 03 terminal, which is connected to the driving signal unit 21. In the present embodiment, FIG. 3 shows an equivalent circuit in essence because the capacitor C2 and the diode D1 are provided inside the MOS transistor Q2.

Alternatively, the above controllable reverse isolation circuit according to the present embodiment can be not to use the capacitor C2 and the diode D1 inside the MOS transistor Q2, but the two ends of the MOS transistor Q2 directly connected in parallel with a diode and a capacitor with better characteristics instead.

In the present embodiment, the first diode D1 is preferably a Schottky diode with high cut off voltage and low reverse current.

Referring to FIGS. 2 and 3, the controllable reverse isolation circuit raises the output voltage of the input AC from the power source U using the transformer T20. After the output voltage is transformed to the DC, it is transferred to the series LED light string 30 to provide the suitable voltage. When the driving signal unit 21 sends an ON signal to the MOS transistor Q1, it also sends the ON signal to the MOS transistor Q2. At then, the MOS transistor Q1 and the MOS transistor Q2 are turned on at the same time. After being boosted by the transformer T20, the boosted output voltage of the power source is transferred to the rectifying circuit to rectify and then provided for the LED light string 30. In this process, because the MOS transistor Q1 and the MOS transistor Q2 are turned on at the same time, the high voltage on the secondary coil L2 of the transformer T20 is conducted to the end, which eliminates the energy stored in the leakage inductance of the secondary coil L2. When the driving signal unit 21 sends an OFF signal to the MOS transistor Q1, it also sends the OFF signal to the MOS transistor Q2. At then, the MOS transistor Q1 and the MOS transistor Q2 are cut off at the same time. The induced electromotive forces on the primary coil L1 and the secondary coil L2 of the transformer T20 are connected in parallel by the first diode D1 inside the MOS transistor Q2, which becomes the voltage of the LED light string 30.

One end of the second capacitor C2 inside the MOS transistor Q2 is connected to the opposite terminal of the primary coil L1 of the transformer T20, and the other end is connected to the dotted terminal of the secondary coil L2 of the transformer T20. When the driving signal unit 21 sends the OFF signal to the MOS transistor Q1 and the MOS transistor Q2 at the same time, the MOS transistor Q1 and the MOS transistor Q2 are cut off at the same time. The induced electromotive forces on the primary coil L1 and the secondary coil L2 of the transformer T20 are connected in series by the first diode D1 inside the MOS transistor Q2, which becomes the voltage of the LED light string 30. The second capacitor C2 can effectively absorb the pulse voltage released from the leakage inductance of transformer T20, which protects the key components, such as the MOS transistor Q1, the MOS transistor Q2 or the first diode D1, to improve the security and the stability of the circuit.

In summary, the present invention uses the MOS transistor Q2 with low on-state losses of power to replace the ordinary diode, the Schottky first diode inside which has higher cut off voltage and lower reverse current, which can increase the efficiency of the entire circuit. Moreover, the second capacitor C2 inside the MOS transistor can effectively absorb the pulse voltage released from the leakage inductance of the transformer T20, which effectively improves the security and stability of the circuit.

The present invention referring to the exemplary embodiment is specifically described and illuminated, but those having ordinary skills in the art should understand that it can changed in various forms and details without departing from the spirit and scope of the claim defined by the present invention.

What is claimed is:

1. An isolated boost circuit, comprising: a voltage input terminal, a driving signal unit, a transformer, and a controllable reverse isolation circuit;
wherein, the transformer comprising a primary coil and a secondary coil, the voltage input terminal connected to the dotted terminal of the primary coil, the opposite terminal of the primary coil connected to a 01 terminal of the controllable reverse isolation circuit, the dotted terminal of the secondary coil connected to a 02 terminal of the controllable reverse isolation circuit, and a 03 terminal of the controllable reverse isolation circuit connected to the driving signal unit.

2. The isolated boost circuit as claimed in claim 1, wherein the controllable reverse isolation circuit comprises a second MOS transistor, inside which a first diode and a second capacitor are provided; one end of the second capacitor is connected to the positive electrode of the first diode and the source of the second MOS transistor, which forms the 01 terminal of the controllable reverse isolation circuit; the other end of the second capacitor is connected to the negative electrode of the first diode and the drain of the second MOS transistor, which forms the 02 terminal of the controllable reverse isolation circuit; and the gate of the second MOS transistor is provided as the 03 terminal of the controllable reverse isolation circuit.

3. The isolated boost circuit as claimed in claim 1, wherein the isolated boost circuit further comprises a first MOS transistor, a first capacitor, a LED light string, and a resistance; the drain of the first MOS transistor is connected to the opposite terminal of the primary coil, the source of that is electrically grounded, and the gate of that is connected to the driving signal unit; the opposite terminal of the secondary coil is connected to the positive electrode of the LED light string; one end of the resistance is connected to the negative electrode of the LED light string, and the other end of that is electrically grounded; and one end of the first capacitor is connected to the positive electrode of the LED light string, and the other end of that is electrically grounded.

4. The isolated boost circuit as claimed in claim 2, wherein the isolated boost circuit further comprises a first MOS transistor, a first capacitor, a LED light string, and a resistance; the drain of the first MOS transistor is connected to the opposite terminal of the primary coil, the source of that is electrically grounded, and the gate of that is connected to the driving signal unit; the opposite terminal of the secondary coil is connected to the positive electrode of the LED light string; one end of the resistance is connected to the negative electrode of the LED light string, and the other end of that is electrically grounded; and one end of the first capacitor is connected to the positive electrode of the LED light string, and the other end of that is electrically grounded.

5. The isolated boost circuit as claimed in claim 3, wherein the isolated boost circuit further comprises a rectifying circuit; a 04 terminal of the rectifying circuit is connected to the opposite terminal of the secondary coil, and a 05 terminal of the rectifying circuit is connected to the positive electrode of the LED light string, which allows the rectifying circuit connected between the opposite terminal of the secondary coil and the positive electrode of the LED light string.

6. The isolated boost circuit as claimed in claim 4, wherein the isolated boost circuit further comprises a rectifying circuit; a 04 terminal of the rectifying circuit is connected to the opposite terminal of the secondary coil, and a 05 terminal of the rectifying circuit is connected to the positive electrode of the LED light string, which allows the rectifying circuit connected between the opposite terminal of the secondary coil and the positive electrode of the LED light string.

7. The isolated boost circuit as claimed in claim 2, wherein the first diode is a Schottky diode.

8. The isolated boost circuit as claimed in claim 5, wherein the rectifying circuit is a second diode; the positive electrode of the second diode is connected to the opposite terminal of the secondary coil, and the negative electrode of the second diode is connected to positive electrode of the LED light string.

9. The isolated boost circuit as claimed in claim 6, wherein the rectifying circuit is a second diode; the positive electrode of the second diode is connected to the opposite terminal of the secondary coil, and the negative electrode of the second diode is connected to positive electrode of the LED light string.

10. A backlight module, comprising a isolated boost circuit which comprises a voltage input terminal, a driving signal unit, a transformer, and a controllable reverse isolation circuit; wherein, the transformer comprising a primary coil and a secondary coil, the voltage input terminal connected to the dotted terminal of the primary coil, the opposite terminal of the primary coil connected to a 01 terminal of the controllable reverse isolation circuit, the dotted terminal of the secondary coil connected to a 02 terminal of the controllable reverse isolation circuit, and a 03 terminal of the controllable reverse isolation circuit connected to the driving signal unit; wherein, the controllable reverse isolation circuit comprising a second MOS transistor, inside which a first diode and a second capacitor are provided; one end of the second capacitor connected to the positive electrode of the first diode and the source of the second MOS transistor, which forms the 01 terminal of the controllable reverse isolation circuit; the other end of the second capacitor connected to the negative electrode of the first diode and the drain of the second MOS transistor, which forms the 02 terminal of the controllable reverse isolation circuit; and the gate of the second MOS transistor provided as the 03 terminal of the controllable reverse isolation circuit.

11. The backlight module as claimed in claim 10, wherein the isolated boost circuit further comprises a first MOS transistor, a first capacitor, a LED light string, and a resistance; the drain of the first MOS transistor is connected to the opposite terminal of the primary coil, the source of that is electrically grounded, and the gate of that is connected to the driving signal unit; the opposite terminal of the secondary coil is connected to the positive electrode of the LED light string; one end of the resistance is connected to the negative electrode of the LED light string, and the other end of that is electrically grounded; and one end of the first capacitor is connected to the positive electrode of the LED light string, and the other end of that is electrically grounded.

12. The backlight module as claimed in claim 11, wherein the isolated boost circuit further comprises a rectifying circuit; a 04 terminal of the rectifying circuit is connected to the opposite terminal of the secondary coil, and a 05 terminal of the rectifying circuit is connected to the positive electrode of the LED light string, which allows the rectifying circuit connected between the opposite terminal of the secondary coil and the positive electrode of the LED light string.

13. The backlight module as claimed in claim 10, wherein the first diode is a Schottky diode.

14. The backlight module as claimed in claim 12, wherein the rectifying circuit is a second diode; the positive electrode of the second diode is connected to the opposite terminal of the secondary coil, and the negative electrode of the second diode is connected to positive electrode of the LED light string.

15. A liquid crystal display device, comprising a liquid crystal panel and a backlight module which provides a light source to the liquid crystal panel;
the backlight module comprising a isolated boost circuit which comprises a voltage input terminal, a driving signal unit, a transformer, and a controllable reverse isolation circuit; wherein, the transformer comprising a primary coil and a secondary coil, the voltage input terminal connected to the dotted terminal of the primary coil, the opposite terminal of the primary coil connected to a 01 terminal of the controllable reverse isolation circuit, the dotted terminal of the secondary coil connected to a 02 terminal of the controllable reverse isolation circuit, and a 03 terminal of the controllable reverse isolation circuit connected to the driving signal unit; wherein, the controllable reverse isolation circuit comprising a second MOS transistor, inside which a first diode and a second capacitor are provided; one end of the second capacitor connected to the positive electrode of the first diode and the source of the second MOS transistor, which forms the 01 terminal of the controllable reverse isolation circuit; the other end of the second capacitor connected to the negative electrode of the first diode and the drain of the second MOS transistor, which forms the 02 terminal of the controllable reverse isolation circuit; and the gate of the second MOS transistor provided as the 03 terminal of the controllable reverse isolation circuit.

16. The liquid crystal display device as claimed in claim 15, wherein the isolated boost circuit further comprises a first MOS transistor, a first capacitor, a LED light string, and a resistance; the drain of the first MOS transistor is connected to the opposite terminal of the primary coil, the source of that is electrically grounded, and the gate of that is connected to the driving signal unit; the opposite terminal of the secondary coil is connected to the positive electrode of the LED light string; one end of the resistance is connected to the negative electrode of the LED light string, and the other end of that is electrically grounded; and one end of the first capacitor is connected to the positive electrode of the LED light string, and the other end of that is electrically grounded.

17. The liquid crystal display device as claimed in claim 16, wherein the isolated boost circuit further comprises a rectifying circuit; a 04 terminal of the rectifying circuit is connected to the opposite terminal of the secondary coil, and a 05 terminal of the rectifying circuit is connected to the positive electrode of the LED light string, which allows the rectifying circuit connected between the opposite terminal of the secondary coil and the positive electrode of the LED light string.

18. The liquid crystal display device as claimed in claim 15, wherein the first diode is a Schottky diode.

19. The liquid crystal display device as claimed in claim 17, wherein the rectifying circuit is a second diode; the positive electrode of the second diode is connected to the opposite terminal of the secondary coil, and the negative electrode of the second diode is connected to positive electrode of the LED light string.
